(19) United States
(12) Patent Application Publication
(10) Pub. No.: US 2008/0053729 A1
(43) Pub. Date: Mar. 6, 2008

(54) Parallel parker

(76) Inventor: Armen Shagbazyan, Glendale, CA (US)

Correspondence Address: WILSON DANIEL SWAYZE, JR., 3804 CLEARWATER CT., PLANO, TX, 75025, US

(21) Appl. No.: 11/516,126

(22) Filed: Sep. 6, 2006

(51) Int. Cl. B60S 9/215

(52) U.S. Cl. 180/202

(57) ABSTRACT

A vehicle for parallel parking includes a front wheel for supporting a portion of a weight of the vehicle, a primary driving wheel to drive the vehicle in a substantially longitudinal direction of the vehicle, a secondary driving wheel to drive the vehicle in substantially a traverse direction of the vehicle.

### FIELD OF THE INVENTION

The present invention relates to a vehicle having more than one set of drive wheels, and more particularly to a vehicle having a set of secondary drive wheels that are substantially perpendicular to the primary drive wheels.

### BACKGROUND OF THE INVENTION

Parking a vehicle in today's urban areas is at best difficult. This is especially true for on street parking. The availability of on street parking is generally limited to parallel parking, and parallel parking can be difficult in light of the additional parking space that is required in order to parallel park.

### SUMMARY THE INVENTION

The present invention includes a vehicle having a primary set of drive wheels and a secondary set of drive wheels. The secondary set of drive wheels is substantially perpendicular to the primary set of drive wheels. As a consequence, when the opportunity for parallel parking arises, the primary set of drive wheels are lifted from the road surface, and the secondary set of drive wheels are utilized to move the vehicle in substantially a perpendicular direction in order to parallel park. The secondary drive wheels can be raised and lowered by the driver of the vehicle. When the secondary drive wheels are lowered to the road surface, the vehicle including the primary drive wheels are raised so that they do not interfere with the parallel parking.

The secondary drive wheels include a DC motor in order to drive the secondary drive wheels.

The secondary drive wheels may include a male motor shaft and a female motor shaft position between the DC motors.

The vehicle may include an activation switch to raise and lower the secondary drive wheels and may include an additional activation switch to rotate the secondary drive wheels either clockwise or counterclockwise.

The vehicle may include hydraulic cylinders or air cylinders which inflate and deflate to raise and lower the secondary drive wheels.

The vehicle may include air/hydraulic pumps to inflate and deflate the air/hydraulic cylinders.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the side of the vehicle of the present invention with the secondary drive wheels retracted;

FIG. 2 illustrates a cross-sectional view of the side of the vehicle of the present invention with the secondary drive wheels extended;

FIG. 3 illustrates a perspective view of the secondary drive wheels of the present invention;

FIG. 4 illustrates an exploded view of the rectangular shape metal pipe of the present invention.

FIG. 5 illustrates an exploded view of the end of the rectangular shape metal pipe in accordance with the teachings of the present invention;

FIG. 6 illustrates a side view of the secondary drive wheels of the present invention;

FIG. 7 illustrates a cross-sectional view of the rectangular shape metal pipe in accordance with the teachings of the present invention;

FIG. 8 illustrates the front view of the hydraulic cylinder in accordance with the teachings of the present invention;

FIG. 9 illustrates a cross section of the larger diameter motor shaft, motor, rectangular shaped metal pipe, female motor shaft and male motor shaft in accordance with the teachings of the present invention.

FIG. 10 illustrates a cross section of the bearing and inner bearing of the present invention;

FIG. 11 illustrates an activation switch to activate and to deactivate the hydraulic pump and the motors in accordance with the teachings of the present invention.

### DETAILED DESCRIPTION

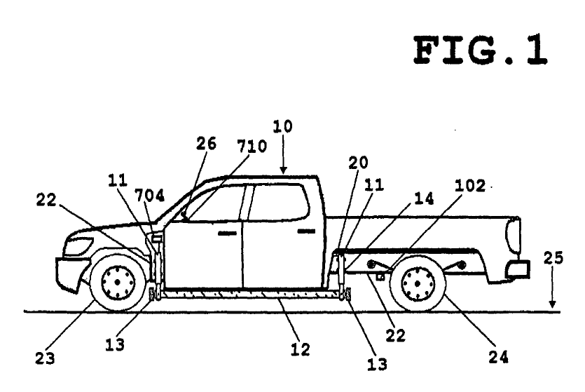

FIG. 1 illustrates the vehicle 10 which may include the automobile or truck and which includes secondary drive wheels in order to provide for convenient parallel parking or any other use where it is desirable to change direction of the vehicles travel. FIG. 1 illustrates the road surface 25 in which the vehicle front tire 23 and a vehicle rear tire 24 support the vehicle 10. The front tire 23 and the rear tire 24 are connected to the vehicle frame 22. The vehicle frame 22 is connected to a first hydraulic cylinder 11 positioned near the front tire 23 and a second hydraulic cylinder 11 positioned in back of the cab of the vehicle 10. The first hydraulic cylinder 11 and a second hydraulic cylinder 11 may be an air cylinder or other suitable device. The first hydraulic cylinder 11 and the second hydraulic cylinder 11 which extend and retract the rectangular shaped metal pipe 12 which is connected to the bearing tire 13 and which are an example of the secondary drive wheels of the present invention. FIG. 1 shows that the first hydraulic cylinder 11 and a second hydraulic cylinder 11 have retracted the rectangular shape metal pipe 12 away from the road surface 25 so that the primary drive wheels shown for example the vehicle rear tire 24 can operate to move the vehicle 10 in the longitudinal direction of the vehicle 10. The first hydraulic cylinder 11 and a second hydraulic cylinder 11 are connected to the vehicle frame 22 by bolt 14 or any other suitable fastening means, and the first hydraulic cylinder 11 and a second hydraulic cylinder 11 are connected to hydraulic hose 20 so that the first hydraulic cylinder 11 and the second hydraulic cylinder 11 can be inflated or deflated so that the rectangular shape metal pipe 12 can be extended or retracted. The rectangular shaped metal pipe 12 can be extended near to the road surface 25 to lift the vehicle 10 so that the vehicle front tire 23 and the vehicle rear tire 24 are off the road surface 25. The vehicle 10 may be lifted between ¼ to 12 inches The bearing tire 13 is connected to the DC motor 15 and can move the vehicle 10 in the traverse direction to the curb. Each sensor 102 detects the curb or side of the road at a predetermined distance from the curb or from the side of the road as the vehicle 10 approaches the curb or the side of the road. The output from the DC motor 15 can be geared down to control the speed of the bearing tire 13. The sensor 102 controls and shuts the DC motor 15 off so that the bearing tire 13 does not move further when the sensor detects the curb.

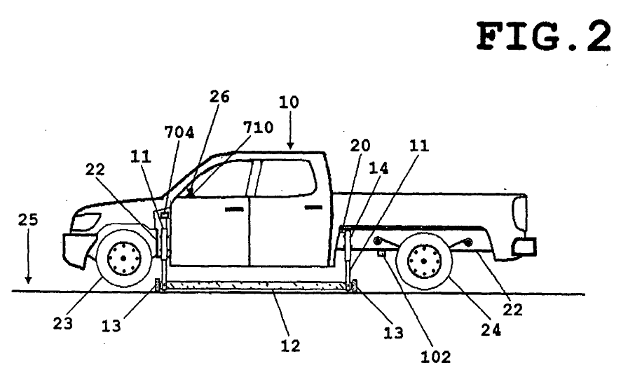

FIG. 2 illustrates that the hydraulic cylinder 11 has been extended so that the bearing tire 13 has taken the weight of the vehicle 10 and lifted the vehicle front tire 23 and the vehicle rear tire 24 off the road surface 25. The rectangular shape metal pipe 24 is adjacent to and substantially parallel to the road surface 25.

FIGS. 1 and 2 have illustrated the left side of the vehicle 10. However, the right side of the vehicle 10 would have complementary secondary drive wheels on the right side of the vehicle 10 which include the first and second hydraulic cylinder 11, the rectangular shape metal pipe 12 and the bearing tire 13.

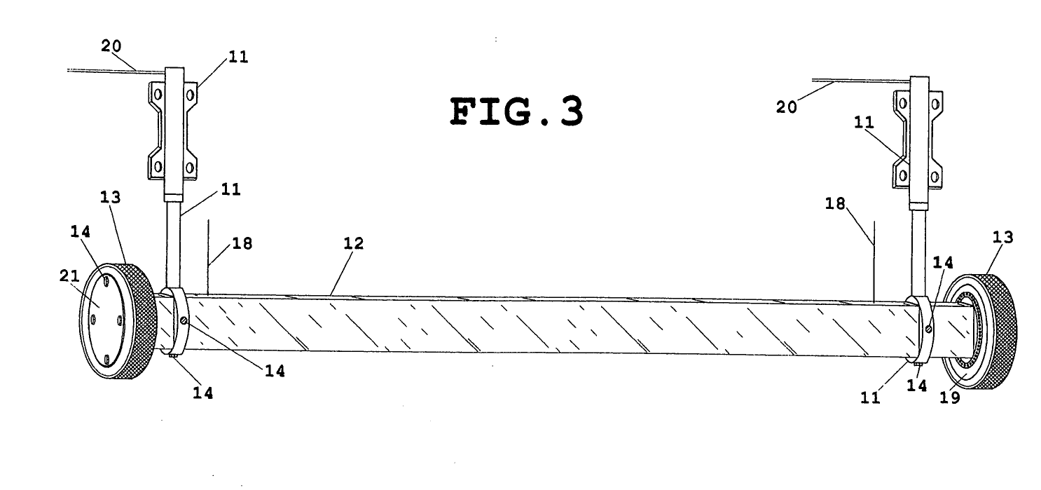

FIG. 3 illustrates the secondary drive wheels of the present invention. The secondary drive wheels include the rectangular shape metal pipe 12 which may be square or cylinder shaped and which extends from a first bearing tire 13 to a second bearing tire 13. The hydraulic cylinder 11 is mounted essentially perpendicular to the rectangular shape metal pipe 12 with one end of the hydraulic cylinder 11 enclosing the periphery of the rectangular shape metal pipe 12 and securing the rectangular shape metal pipe 12. The hydraulic cylinder 11 is connected to the hydraulic hose 20 to expand and retract the hydraulic cylinder 11. At each end of the rectangular shape metal pipe 12 is a larger diameter motor shaft 21 which is connected to the DC motor 15.

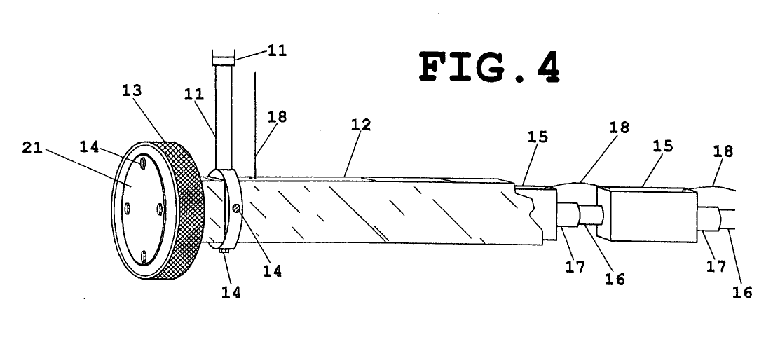

FIG. 4 illustrates that the rectangular shape metal pipe 12 includes a series or plurality of DC motors 15 which are connected in series by a female motor shaft 17 which is connected to a male motor shaft 16. The DC motors 15 are electrically connected by electrical wires 18 to provide power to the DC motors 15 and to control the DC motors 15.

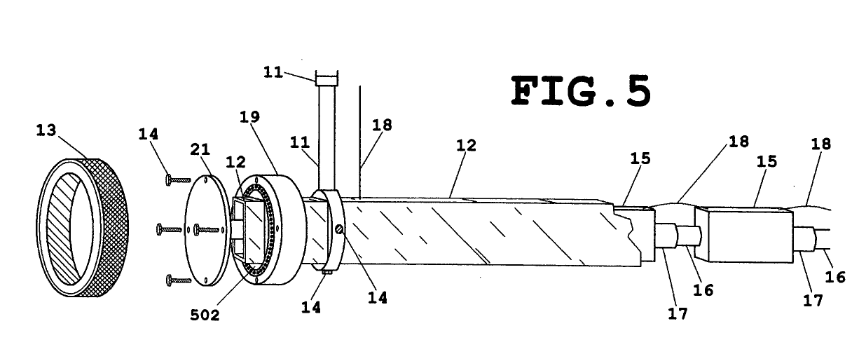

FIG. 5 illustrates the end of the rectangular shape metal pipe 12 including an bearing tire 13 which is positioned over the bearing 19 which is positioned over the inner bearing 502. The larger diameter motor shaft 21 covers the end of the rectangular shaped metal pipe 12. The bearing 19 is attached to the larger diameter motor shaft 21 with bolts 14.

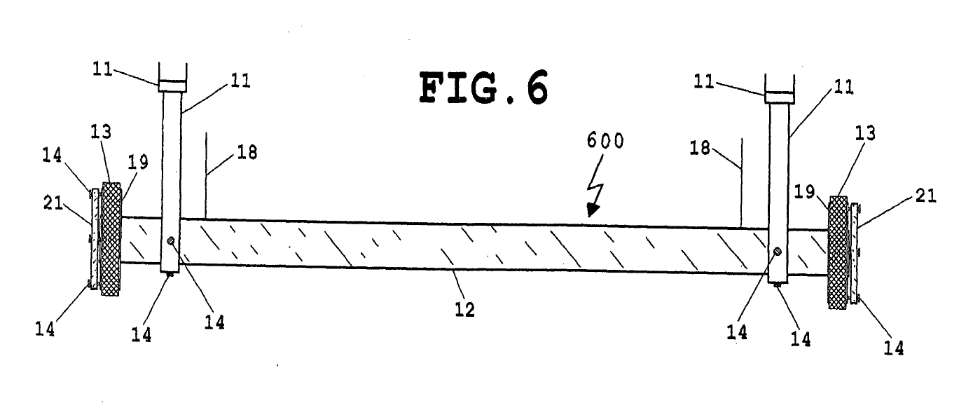

FIG. 6 illustrates the secondary drive wheels 600 of the present invention. The drive wheels 600 include a bearing tire 13 to be extended and to connect with the road surface 25, a rectangular shape metal pipe 12 to extend between the first bearing tire 13 and the second bearing tire 13, a bearing 19 to connect to the first bearing tire 13 and the second bearing tire 13. FIG. 6 additionally illustrates the hydraulic cylinder 11 which is connected to the rectangular shape metal pipe 12 by bolt 14 and a larger diameter motor shaft 21 which is connected to the bearing 19 by the bolt 14. FIG. 6 additionally illustrates electrical wire 18 which are connected to the DC motor 15.

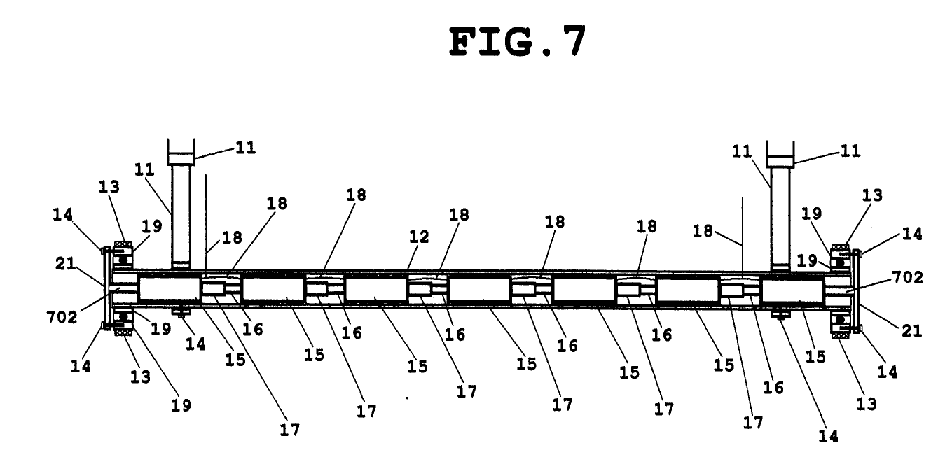

FIG. 7 illustrates that the DC motors 15 are to turn the bearing tire 13 so that the vehicle 10 moves towards or away from the side of the road surface 25. FIG. 7 illustrates a series of DC motors 15. However, more, fewer or one motor 15 could be used with the present invention. The DC motors 15 are connected by a female motor shaft 17 and a male motor shaft 16. The DC motor 15 at the end of the rectangle shape metal pipe 12 includes a end shaft 702 to connect to the larger diameter motor shaft 21 which in turn turns the bearing 19 which turns the bearing tire 13. FIG. 7 additionally illustrates that the electrical wire 18 connects to the rectangular shape metal pipe 12 to connect to the DC motors 15. The DC motors 15 includes a locking mechanism which locks said DC motors 15 unless the DC motors 15 are powered with electricity. The sensor 102 detects the distance from the curb to the vehicle 10 to shut down the DC motor 15 at a predetermined distance from the curb. The end DC motors 15 include larger diameter end shaft 21 which include threaded holes to accept bolts 14 to the bearing.

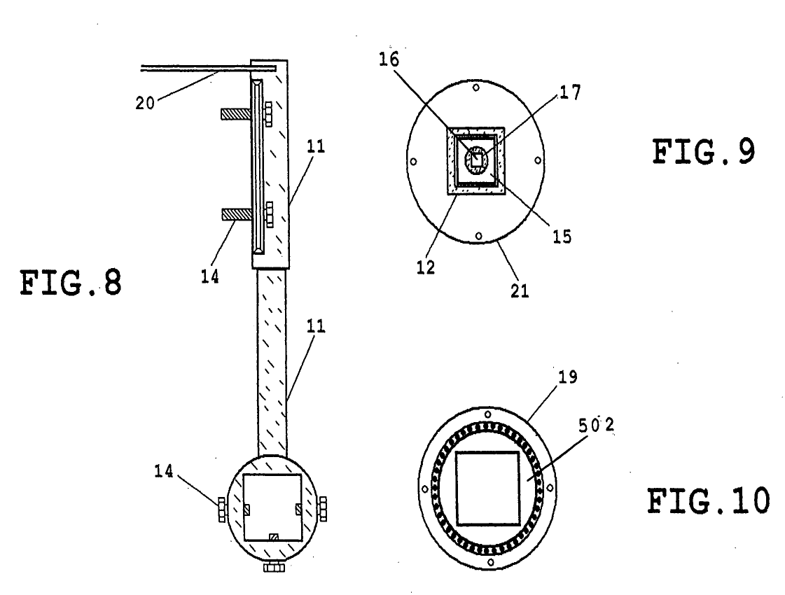

FIG. 8 illustrates a front view of the hydraulic cylinder 11 of the present invention. The hydraulic cylinder 11 is connected to hydraulic hose 20 supply hydraulic fluid to the hydraulic cylinder 11 to allow the hydraulic cylinder 11 to expand or retract. The periphery of the rectangular shaped metal pipe 12 is connected to the hydraulic cylinder 11 by bolts 14.

FIG. 9 illustrates a cross-sectional view of the larger diameter motor shaft 21, the rectangular shape metal pipe 12, the DC motor 15, the female motor shaft 17 and the male motor shaft 16.

FIG. 10 illustrates the inner bearing 502 in the bearing 19 connecting to the periphery of the rectangular shape metal pipe 12.

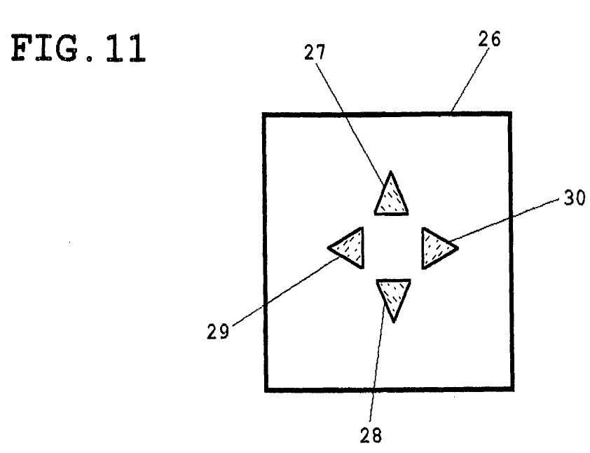

FIG. 11 illustrates the activation switch 26 located on the steering wheel 710 within the vehicle 10. The activation switch includes a hydraulic pump activation button 27 to activate the hydraulic pump 704, a hydraulic pump deactivation button 28 to deactivate the hydraulic pump 704, an activation button 30 to activate the DC motor 15 to rotate clockwise and an activation button 29 to activate the DC motors 15 to rotate counterclockwise.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A vehicle for parallel parking, comprising:
a front wheel for supporting a portion of a weight of said vehicle;
a primary driving wheel to drive said vehicle in a substantially longitudinal direction of said vehicle;
a secondary driving wheel to drive said vehicle in substantially a traverse direction of said vehicle.

2) A vehicle for parallel parking as in claim 1, wherein said secondary driving wheel is connected to a hydraulic cylinder to be extended and retracted.

3) A vehicle for parallel parking as in claim 1, wherein said secondary driving wheel is connected to an air cylinder to be extended and retracted.

4) A vehicle for parallel parking as in claim 2, wherein said hydraulic cylinder is connected to a hydraulic pump to expand and retract said secondary driving wheel.

5) A vehicle for parallel parking as in claim 3, wherein said air cylinder is connected to an air pump to expand and retract said secondary driving wheel.

6) A vehicle for parallel parking as in claim 4, wherein said hydraulic pump is positioned under a hood of said vehicle.

7) A vehicle for parallel parking as in claim 5, wherein said air pump is positioned under a hood of said vehicle.

8) A vehicle for parallel parking as in claim 6, wherein said hydraulic pump is controlled by an activation switch.

9) A vehicle for parallel parking as in claim 7, wherein said air pump is controlled by an activation switch.

10) A vehicle for parallel parking as in claim 1, wherein said secondary driving wheel is powered by a DC motor.

11) A vehicle for parallel parking as in claim 1, wherein said DC motor is controlled by an activation switch.

12) A vehicle for parallel parking as in claim 11, wherein said DC motor may be activated manually and may be deactivated automatically.

13) A vehicle for parallel parking as in claim 12 wherein said vehicle includes a sensor to measure the distance between the curb and the sensor in order to deactivate the DC motor automatically.

14 A vehicle for parallel parking as in claim 11, wherein said DC motor is connected to a male motor shaft.

15) A vehicle for parallel parking as in claim 11, wherein said DC motor is connected to a female motor shaft.

16) A vehicle for parallel parking as in claim 11, wherein said DC motor may rotate in a first and a second direction (clockwise and counterclockwise).

17) A vehicle for parallel parking as in claim 1, wherein said secondary drive wheel includes a first drive wheel which is connected to a rectangular shape metal pipe to connect to a second drive wheel.

18) A vehicle for parallel parking as in claim 11, wherein said DC motor includes a locking mechanism to lock said DC motor unless electrical power is applied to said DC motor.

19) A vehicle for parallel parking as in claim 1, wherein said rectangular shape metal pipe includes a bearing to connect to said secondary drive wheel.
